(19) United States
(12) Patent Application Publication
(10) Pub. No.: US 2024/0298170 A1
(43) Pub. Date: Sep. 5, 2024

(54) UE ID EXPOSURE

(71) Applicant: Telefonaktiebolaget LM Ericsson (publ), Stockholm (SE)

(72) Inventor: Wenliang XU, Shanghai (CN)

(73) Assignee: Telefonaktiebolaget LM Ericsson (publ), Stockholm (SE)

(21) Appl. No.: 18/260,239

(22) PCT Filed: Nov. 16, 2021
(86) PCT No.: PCT/CN2021/130810

§ 371 Date: Jun. 30, 2023

(30) Foreign Application Priority Data
Jan. 12, 2021 (WO) PCTCN2021071177

(51) Int. Cl. H04W 8/26; H04W 60/04; H04W 76/10

(52) U.S. Cl. CPC H04W 8/26; H04W 60/04; H04W 76/10

(57) ABSTRACT

The disclosure relates to User Equipment (UE) Identifier (ID) exposure. In an embodiment, there proposes a method performed by a first network function implementing application data management function in a data network, comprising: receiving, from a UE, a first message comprising UE information indicating a dynamic UE Identity; and based on the received UE information, obtaining, from a second network function in a mobile communication network, a static UE ID to be exposed. With embodiments herein, the solution provides a way to obtain a static UE ID for the UE so that UE can identify itself with such ID to further communicate with the Edge Enabler Server or the Edge Configuration Server.

### TECHNICAL FIELD

The embodiments herein relate generally to the field of communication, and more particularly, the embodiments herein relate to User Equipment (UE) Identifier (ID) exposure.

### BACKGROUND

3GPP TS23.558 Release 17 (v1.2.0) specifies the application layer architecture, procedures and information flows necessary for enabling edge application over 3GPP networks. It includes architectural requirements for enabling edge applications, application layer architecture fulfilling the architecture requirements and procedures to enable the deployment of edge applications.

### SUMMARY

Enabler layer is provided for integrating the common features of the edge application; and interactions of the enabler client in the enabler layer need to supply a static UE ID (either mandatory or optional). However, due to security concern, the enabler client of the edge application cannot provide or even obtain a trustworthy static UE ID for exposing.

In view of above problem, the embodiments herein provide solutions for enabler client of the edge application to supply a static UE ID for further identifying the UE.

In an embodiment, there proposes a first method performed by a first network function implementing application data management function in a data network. The first method may comprise a step of: receiving, from a UE, a first message comprising UE information indicating a dynamic UE Identity. The first method may further comprise a step of: based on the received UE information, obtaining, from a second network function in a mobile communication network, a static UE ID to be exposed.

In an embodiment, the first method may further comprise a step of: in response to the first message, transmitting, to the UE, a second message including the static UE ID, for exposing the static UE ID to UE and/or further to a third network function.

In an embodiment, the UE information indicates UE Internet Protocol (IP) address assigned in a Packet Data Unit (PDU) session establishment process.

In an embodiment, the static UE ID is an application specific external ID assigned by a fourth network function in the data network or in the mobile communication network.

In an embodiment, the second network function is a network function implementing a network exposure function. Furthermore, the above step of obtaining the UE ID may further comprise the step of: interacting with the second network function implementing the network exposure function to retrieve the UE ID, by using the received UE IP address.

In an embodiment, the second network function implementing the network exposure function is Service Capability Exposure Function (SCEF), Network Exposure Function (NEF), or a combined SCEF+NEF.

In an embodiment, the first network function further comprises an Application Programming Interface (API) specific for the first and second messages.

In an embodiment, the first network function is implemented in an Edge Configuration Server (ECS), and the first and second messages are sent over EDGE-4 reference point between an Edge Enabler Client (EEC) in the UE and the ECS.

In an embodiment, the first message is any one of Service Provisioning Request message, Service Provisioning Subscription Request message, or UE Identifier API Request message. Furthermore, the second message is a response message respective to the first message.

In an embodiment, the first network function is implemented in an EES, and the first and second messages are sent over EDGE-1 reference point between an EEC in the UE and the EES.

In an embodiment, the first message is any one of UE Identifier API Request message, EEC Registration message, Edge Application Server (EAS) discovery message, or Application Context Relocation (ACR) message. Furthermore, the second message is a response message respective to the first message. In another embodiment, there proposes a second method performed by a UE. The first method may comprise a step of: transmitting, to a first network function implementing application data management function in a data network, a first message comprising UE information indicating a dynamic UE ID.

In an embodiment, the first method may further comprise a step of receiving, from the first network function, a second message including a static UE identifier (ID) to be exposed.

In an embodiment, the first method may further comprise a step of: transmitting, to a second network function, a third message including the static UE ID, for exposing the static UE ID.

In an embodiment, the UE information indicates UE IP address assigned in a PDU session establishment process.

In an embodiment, the static UE ID is an application specific external ID assigned by a third network function in the data network or in the mobile communication network.

In an embodiment, the first and second messages are sent over an API specific for the first and second message.

In an embodiment, the first network function is implemented in an ECS, and the first and second messages are sent over EDGE-4 reference point between an EEC in the UE and the ECS.

In an embodiment, the first message is any one of Service Provisioning Request message, Service Provisioning Subscription Request message, or UE Identifier API Request message. Furthermore, the second message is a response message respective to the first message.

In an embodiment, the first network function is implemented in an EES, and the first and second messages are sent over EDGE-1 reference point between an EEC in the UE and the EES.

In an embodiment, the first message is any one of UE Identifier API Request message, EEC Registration message, EAS discovery message, or ACR message. Furthermore, the second message is a response message respective to the first message.

In yet another embodiment, there proposes a first network function implementing application data management function in a data network, comprising: at least one processor; and a non-transitory computer readable medium coupled to the at least one processor, the non-transitory computer readable medium contains instructions executable by the at least one processor, whereby the at least one processor is configured to perform the first method.

In yet another embodiment, there proposes a UE, comprising: at least one processor; and a non-transitory computer readable medium coupled to the at least one processor, the non-transitory computer readable medium contains instructions executable by the at least one processor, whereby the at least one processor is configured to perform the second method.

In yet another embodiment, there proposes a computer readable medium comprising computer readable code, which when run on an apparatus, causes the apparatus to perform any of the above method.

In yet another embodiment, there proposes a computer program product comprising computer readable code, which when run on an apparatus, causes the apparatus to perform any of the above method.

With embodiments herein, the solution provides a way to obtain a static UE ID for the UE so that UE can identify itself with such ID to further communicate with the EES or the Edge ECS.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing an example communication system, in which the embodiments herein may be implemented;

FIG. 2 is a schematic signaling chart showing the messages in a service provisioning procedure;

FIG. 3 is a schematic signaling chart showing the messages in a service provisioning request procedure;

FIG. 4 is a schematic signaling chart showing interactions between the EEC and the EES via UE Identifier API;

FIG. 5 is a schematic signaling chart showing interactions between the EEC and the ECS via UE Identifier API;

FIG. 6 is a schematic flow chart showing an example method in the first network function, according to the embodiments herein;

FIG. 7 is a schematic flow chart showing an example method in the UE, according to the embodiments herein;

FIG. 8 is a schematic block diagram showing an example first network function, according to the embodiments herein;

FIG. 9 is a schematic block diagram showing an example UE, according to the embodiments herein;

FIG. 10 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

FIG. 1 is a schematic block diagram showing an example communication system 100, in which the embodiments herein may be implemented. FIG. 1 shows example architecture for enabling EDGE application(s).

The EDN 103 may be a local Data Network. EAS(s) 121 and the EES 122 may be contained within the EDN 103. The ECS 123 may provide configurations related to the EES 122, including details of the EDN 123 hosting the EES 122. The UE 101 may contain Application Client(s) 111 and the EEC 112. The EAS(s) 121, the EES 122 and the ECS 123 may interact with the 3GPP Core Network 102.

EDGE-1 reference point enables interactions between the EES 122 and the EEC 112. It supports: a) registration and de-registration of the EEC 112 to the EES 122; b) retrieval and provisioning of EAS configuration information; and c) discovery of EASs 121 available in the EDN 103.

EDGE-4 reference point enables interactions between the ECS 123 and the EEC 112. It supports: a) provisioning of Edge configuration information to the EEC 112.

Currently, EDGE-1 and EDGE-4 interactions (e.g. EEC registration, EAS discovery, ACR determination) need EEC 112 to supply a static UE ID (either mandatory or optional).

The UE ID may be in the form of Generic Public Subscription Identifier (GPSI), UE IP address. GPSI may be in the form of Mobile Subscriber Integrated Services Digital Network Number (MSISDN) or external UE ID. The external UE ID and MSISDN are static UE ID, since they do not change when the PDU session is torn down. UE IP address is a dynamic UE ID which is only valid when the PDU session is active. The UE IP address may be recycled after PDU session is released and assigned to another UE.

The MSISDN may be retrieved by the EEC 112 (which is an application in the UE 101) from Universal Subscriber Identity Module (USIM) card of the UE 101. However, due to security concern such as user privacy concern, the user may not allow such information to be exposed. Additionally, due to security concern such as forgery risk concern, the Application Client 111 within the UE 101 may not be a trustworthy source for UE ID.

In view of the above, the application specific external UE ID (such as Application Function (AF) specific external UE ID), which is a network provided identifier, may be considered, since there is no security concern such as privacy concern or forgery risk concern.

The embodiments herein provide the solution for UE to supply a static UE ID over EDGE-1 and EDGE-4 reference points so that the ECS 123/EES 112 can further identify the UE. For example, the embodiments herein may allow EEC to send the UE Identity (such as UE IP address) directly as UE identifier over EDGE-1 and EDGE-4 reference points.

For example, the embodiments herein may provide at least two alternatives as follows.
(1). the EEC 112 may supply UE IP address directly to the ECS 123/EES 122, and the ECS 123/EES 122 may request 3GPP core network to translate it to a static UE ID;
(2). the EEC 112 may request such information from the ECS 123/EES 122, which in turn requests it from the 3GPP core network.

For alternative (1), it can be used directly for the EDGE-4 interaction (e.g. service provisioning) to avoid additional UE ID capability exposed by the ECS 123.

For alternative (2), it utilizes the UE ID capability exposed by the EES 122 (e.g. Eees_UEIdentifier or Eecs_UEIdentifier API) and can be used by the EEC 112 to retrieve UE ID once for all EDGE-1 or EDGE-4 interactions.

In an embodiment, for EDGE-4 interaction, the alternative (1) is used, and for EDGE-1 interaction, the alternative (2) is used. However, for another embodiment, both alternatives (1) and (2) may be used for EDGE-1 interaction; and/or both alternatives (1) and (2) may be used for EDGE-4 interaction.

Note that, it is possible for the ECS 123 or EES 122 to derived the UE IP address from the incoming packet in the user plane, but such UE IP address is not the one allocated by the 3GPP core network 102 if a Network Address Translation (NAT) is used between the User Plane Function and the ECS 123 or EES 122. The EEC 112 provided UE IP address is the one allocated by the 3GPP core network 102 which can be retrieved from the UE modem and such UE IP address can be used by the ECS 123 or EES 122 to interact with the 3GPP core network 102 without considering the NAT issue.

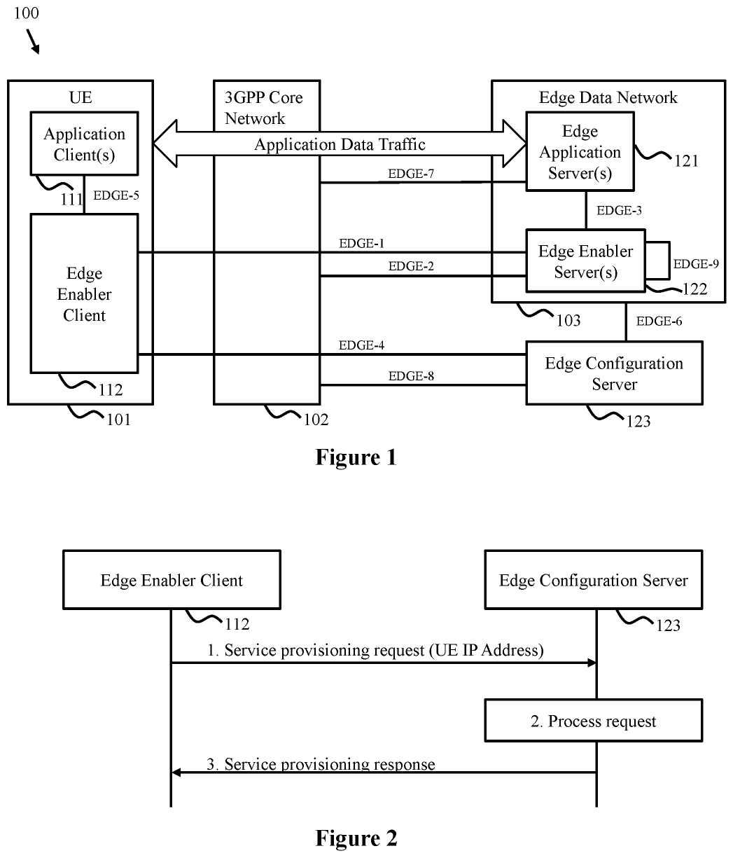

FIG. 2 is a schematic signaling chart showing the messages in a service provisioning procedure based on request/response model. In an embodiment, as shown in FIG. 2, for EDGE-4 reference point, the EEC 112 may include UE IP address directly to identify the UE 101.

In an embodiment, the following pre-conditions are satisfied before performing the service provisioning procedure.

(1). The EEC 112 has been pre-configured or has discovered the address (e.g. Uniform Resource Identifier, URI) of the ECS 123; (2). The EEC 112 has been authorized to communicate with the ECS 123;

(3). The UE ID is either preconfigured or resulted from a successful authorization (for example, the UE ID is resulted from authorization process with 3GPP Core Network 102); and
(4). The ECS 123 is configured with Edge Computing Service Provider (ECSP) policy for service provisioning.

In an embodiment, the signaling chart may include the following messages or steps:
Step 1. The EEC 112 may send a service provisioning request message to the ECS 123. The service provisioning request message may include the security credentials of the EEC 112 received during EEC authorization procedure and may include the UE ID (such as GPSI), connectivity information, UE location and Application Client profile(s) information.

In an embodiment, the service provisioning request message may include information indicating UE Identity. For example, the UE Identity may be a dynamic UE Identity, such as UE IP address which is assigned during a PDU session establishment process with the 3GPP Core Network 102.

In an embodiment, the information elements for service provisioning request from the EEC 112 to the ECS 123 is shown in table 1.

TABLE 1
Service provisioning request

| Information | | |
|---|---|---|
| element | Status | Description |
| EEC ID | M | Unique identifier of the EEC. |
| Security | M | Security credentials resulting from a successful |
| credentials | | authorization for the edge computing service. |
| Application | O | Information about services the EEC wants to |
| Client | | connect to, as described in Table 8.2.2-1. |
| Profile(s) | | |
| UE Identifier | O | The identifier of the UE (i.e. GPSI or identity |
| | | token) |
| UE IP address | O | The UE IP address. |
| Connectivity | O | List of connectivity information for the UE, |
| information | | e.g. PLMN ID, SSID. |
| UE location | O | The location information of the UE. The UE |
| | | location is described as clause 7.3.2. |

Step 2. Upon receiving the service provisioning request message, the ECS 123 may performs an authorization check to verify whether the EEC 112 has authorization to perform the operation. The ECS 123 may utilize the capabilities (e.g. UE location) of the 3GPP core network 102. The ECS 123 may use the received UE IP address to contact Policy and Charging Rules Function (PCRF) or Policy Control Function (PCF) to retrieve UE location. If SCEF, NEF, or a combined SCEF+NEF is used to retrieve UE location, the ECS 123 may interact with the 3GPP core network 102 to retrieve UE ID using the received UE IP address and then may interact with SCEF/NEF/SCEF+NEF. If Application Client profile(s) are provided by the EEC 112, the ECS 123 may identify the EES(s) 122 based on the provided Application Client profile(s) and the UE location. When Application Client profiles(s) are not provided, then:
if available, the ECS 123 may identify the EES(s) 122 based on the UE-specific service information at the ECS 123 and the UE location;
the ECS 123 may identify the EES(s) 122 by applying the ECSP policy (e.g. based only on the UE location).

The ECS 123 may also determine other information that needs to be provisioned, e.g. identification of the EDN 103, topological service area information (for Local Area Data Network, LADN), EES endpoints.

If the ECS 123 is unable to determine the EES information using the inputs in service provisioning request, UE-specific service information at the ECS or the ECSP's policy, the ECS 123 shall reject the service provisioning request and respond with an appropriate failure cause.

Step 3. If the processing of the service provisioning request message was successful, the ECS 123 may respond to the request of EEC 112 request with a service provisioning response which may include a list of EDN configuration information, e.g. identification of the EDN 103, topological service area information (for LADN), and the required information (e.g. URI, IP address) for establishing a connection to the EES 122.

If the EDN configuration information includes an LADN Data Network Name (DNN) as an identifier for the EDN 103, the EEC 112 may consider the LADN as the EDN 103. Therefore, the service area of EDN 103 is the LADN Service Area which can be discovered using the UE Registration Procedure. The EEC 112 may cache the service provisioning information (e.g. EES endpoint) for subsequent use and avoid the need to repeat step 1. If the lifetime information element is included in the Service provisioning response, then the EEC 112 may cache and reuse the Service provisioning information only for the duration specified by the lifetime information element, without the need to repeat step 1.

Note that, if the service provisioning request fails, the EEC 112 can resend the service provisioning request again, including the missing information as indicated by the received failure cause.

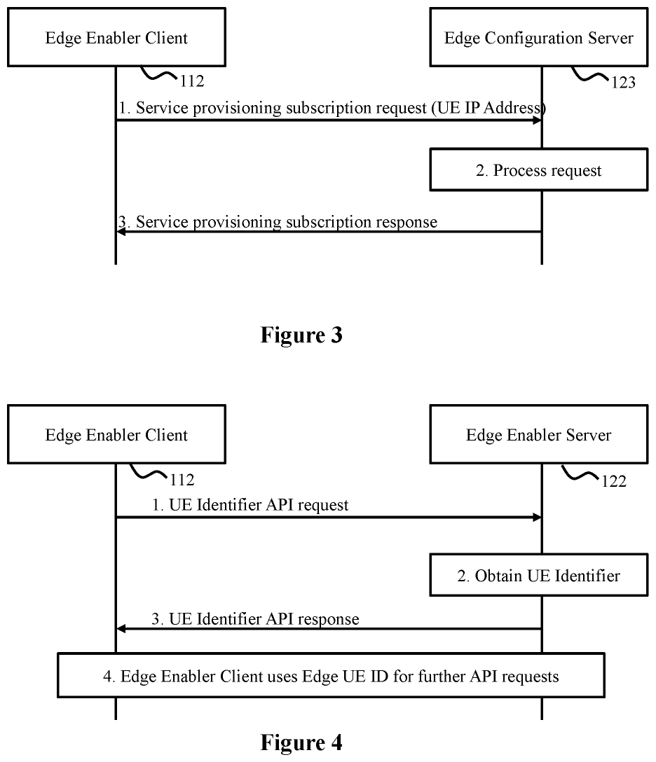

FIG. 3 is a schematic signaling chart showing the messages in a service provisioning request procedure between the EEC 112 and the ECS 123. In an embodiment, as shown in FIG. 3, for EDGE-4 reference point, the EEC 112 may include UE IP address directly to identify the UE 101.

In an embodiment, the following pre-conditions are satisfied before performing the service provisioning procedure.
(1). The EEC 112 has been pre-configured or has discovered the address (e.g. URI) of the ECS 123;
(2). The EEC 112 has been authorized to communicate with the ECS 123 as specified in the description with respect to FIG. 2;
(3). The UE ID is either preconfigured or resulted from a successful authorization (for example, the UE ID is resulted from authorization process with 3GPP Core Network 102); and
(4). The ECS 123 is configured with ECSP policy for service provisioning.

In an embodiment, the signaling chart may include the following messages or steps:

Step 1. The EEC 112 may send a service provisioning subscription request message to the ECS 123. The service provisioning subscription request message may include the security credentials of the EEC 112 received during EEC authorization procedure and may include the UE ID (such as GPSI), connectivity information, proposed expiration time and Application Client Profile information.

In an embodiment, the service provisioning subscription request message may include information indicating UE Identity. For example, the UE Identity may be a dynamic UE Identity, such as UE IP address which is assigned during a PDU session establishment process with the 3GPP Core Network 102.

In an embodiment, the information elements for service provisioning subscription request from the EEC 112 to the ECS 123 is shown in table 2.

TABLE 2
Service provisioning subscription request

| Information | | |
|---|---|---|
| element | Status | Description |
| EEC ID | M | Unique identifier of the EEC. |
| Security | M | Security credentials resulting from a successful |
| credentials | | authorization for the edge computing service. |
| Application | O | Information about services the EEC wants to |
| Client | | connect to, as described in Table 8.2.2-1. |
| profile(s) | | |
| UE Identifier | O | The identifier of the UE (i.e. GPSI or identity |
| | | token) |
| UE IP address | O | The UE IP address. |
| Connectivity | O | List of connectivity information for the UE, |
| information | | e.g. PLMN ID, SSID. |
| Proposed | O | Proposed expiration time for the subscription |
| expiration time | | |

Step 2. Upon receiving the service provisioning subscription request message, the ECS 123 may perform an authorization check to verify whether the EEC 112 has authorization to perform the operation. If required, the ECS 123 may utilize the capabilities (e.g. UE location) of the 3GPP core network 102. The ECS 123 may use the received UE IP address to contact PCRF/PCF to retrieve UE location. If SCEF/NEF/SCEF+NEF is used to retrieve UE location, the ECS 123 may interact with the 3GPP core network 102 to retrieve UE ID using the received UE IP address and then may interact with SCEF/NEF/SCEF+NEF. If the ECS 123 is unable to determine the EES information using the inputs in service provisioning subscription request, UE-specific service information at the ECS or the ECSP policy, the ECS 123 shall reject the service provisioning subscription request and respond with an appropriate failure cause. If the request is authorized, the ECS 123 may create and store the subscription for provisioning.

Step 3. If the processing of the service provisioning subscription request message was successful, the ECS 123 may respond with a service provisioning subscription response, which includes the subscription identifier and may include the expiration time indicating when the subscription will automatically expire. To maintain the subscription, the EEC 112 shall send a Service provisioning subscription update request prior to the expiration time. If a Service provisioning subscription update request is not received prior to the expiration time, the ECS 123 shall treat the EEC 112 as implicitly unsubscribed.

Note that, if the service provisioning subscription request fails, the EEC 112 can resend the service provisioning subscription request again, including the missing information as indicated by the received failure cause.

The above description in combination with FIGS. 2 and 3 provide an example of obtaining UE ID based on EDGE-4 interactions (for example Service Provisioning Request message, Service Provisioning Subscription Request message). Similarly, EDGE-1 interactions (for example, EAS registration, EEC Registration message, EAS discovery message, ACR Initiation message, or ACR determination message) may include the UE IP address to identify the UE 101 and the EES 122 may obtain UE ID from the 3GPP core network 102.

FIG. 4 is a schematic signaling chart showing interactions between the EEC 112 and the EES 122 via UE Identifier API.

In an embodiment, as shown in FIG. 4, for EDGE-1 reference point, the EEC 112 may send UE Identifier API request with UE IP address to the EES 122, and EES 122 may interact with 3GPP core network 102 to retrieve UE ID corresponding to the UE IP address. Then EES 122 may respond to EEC 112 with the obtained UE identifier as Edge UE ID.

The EES 122 may expose UE Identifier API to the EAS 121 in order to provide an identifier uniquely identifying a UE. This API is used by an EAS 121 to obtain the identifier of the UE if the EAS 122 does not have it. This identifier, called Edge UE ID, is used by the EAS 121 to invoke capability APIs specific to UEs over EDGE-3 reference point.

The EES 122 may expose UE Identifier API to the EEC 112. The EEC 112 may request UE ID from the EES 122 if the EEC 112 does not have such information.

In an embodiment, the following pre-conditions are satisfied before performing the UE Identifier API request.

(1). The EEC 112 is authorized to discover and to use UE Identifier API provided by the EES 122.

In an embodiment, the signaling chart may include the following messages or steps:

Step 1. The EEC 112 may invoke UE Identifier API request via UE Identifier API exposed by the EES 122.

In an embodiment, the APIs for UE Identifier exposed by the EES 122 for both the EAS 121 and the EEC 112 is shown in table 3.

TABLE 3
Eees_UE_Identifier API

| API Name | API Operations | Operation Semantics | Consumer(s) |
|---|---|---|---|
| Eees_UEIdentifier | Get | Request/Response | EAS, EEC |

Step 2. The EES 122 may use the received user information in the step 1 (e.g. UE IP address) and obtain the UE identifier.

In an embodiment, the EES 122 may determine the Edge UE ID based on for e.g. pre-configurations, an interaction with the 3GPP core network 102.

Step 3. The EES 122 may provide the obtained UE ID as Edge UE ID to the EEC 112. The Edge UE ID is specific to the given EAS 121 and may be assigned by the EES 122 or the 3GPP Core Network 102.

Step 4. The EEC 112 may use the Edge UE ID received in step 3 for further API requests, for example EEC 112 may use the received UE ID for EDGE-1 or EDGE-4 interactions (e.g. EEC registration, EAS discovery, Application Context Relocation (ACR) initiation/determination), in order to supply a static UE ID.

Note that, the EES 122 can provide an updated Edge UE ID to the EEC 112 if the Edge UE ID has changed due to privacy reason (e.g., change of GPSI).

Note that, the EES 122 can also invalidate an Edge UE ID, previously provided to an EEC 112, if there is no need to support the Edge UE ID anymore.

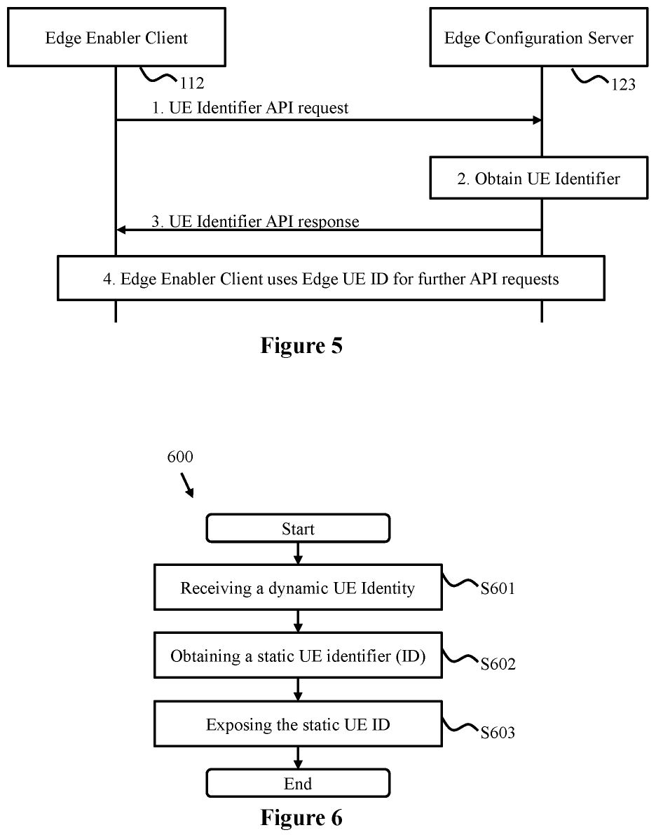

FIG. 5 is a schematic signaling chart showing interactions between the EEC 112 and the ECS 123 via UE Identifier API.

In an embodiment, as shown in FIG. 5, for EDGE-4 reference point, the EEC 112 may send UE Identifier API request with UE IP address to the ECS 123, and the ECS 123 may interact with 3GPP core network 102 to retrieve UE ID corresponding to the UE IP address. Then the ECS 123 may respond to EEC 112 with the obtained UE identifier as Edge UE ID.

The ECS 123 may also expose UE Identifier API to the EEC 112. The EEC 112 may also request UE ID from the ECS 123 if the EEC 112 does not have such information.

In an embodiment, the following pre-conditions are satisfied before performing the UE Identifier API request.

(1). The EEC 112 is authorized to discover and to use UE Identifier API provided by the ECS 123.

In an embodiment, the signaling chart may include the following messages or steps:

Step 1. The EEC 112 may invoke UE Identifier API request via UE Identifier API exposed by the ECS 123.

In an embodiment, the APIs for UE Identifier exposed by the ECS 123 for the EEC 112 is shown in table 4.

TABLE 4
Eecs_UE_Identifier API

| API Name | API Operations | Operation Semantics | Consumer(s) |
|---|---|---|---|
| Eecs_UEIdentifier | Get | Request/Response | EEC |

Step 2. The ECS 123 may use the received user information in the step 1 (e.g. IP address) and obtain the UE identifier.

In an embodiment, the ECS 123 may determine the Edge UE ID based on for e.g. pre-configurations, an interaction with the 3GPP core network 102.

Step 3. The ECS 123 may provide the obtained UE ID as Edge UE ID to the EEC 112. The Edge UE ID is specific to the given EAS 121 and may be assigned by the ECS 123, or the 3GPP Core Network 102.

Step 4. The EEC 112 may use the Edge UE ID received in step 3 for further API requests, for example EEC 112 may use the received UE ID for EDGE-1 or EDGE-4 interactions (e.g. EEC registration, EAS discovery, Application Context Relocation (ACR) initiation/determination), in order to supply a static UE ID.

The ECS 123 can provide an updated Edge UE ID to the EEC 112 if the Edge UE ID has changed due to privacy reason (e.g., change of GPSI).

The ECS 123 can also invalidate an Edge UE ID, previously provided to an EEC 112, if there is no need to support the Edge UE ID anymore.

The embodiments above may provide means about how to supply a static UE ID (without security concern), and alternatively supplying a dynamic UE ID over EDGE-1 and EDGE-4 interactions, as shown in the above description with respect to FIGS. 2-5.

Note that, the above description uses Edge application as an example, similarly the embodiments herein may be also applicable to other applications with enabler layer, such as Factories of the Future (FF), Vehicle to Everything (V2X), Unmanned Aerial System (UAS), Smart Grid, and so on.

FIG. 6 is a schematic flow chart showing an example method 600 in the first network function, according to the embodiments herein. In an embodiment, the flow chart in FIG. 6 may be implemented in an application data management function (such as the EES 122 or the ECS 123) in a data network (such as EDN 100), as shown in FIGS. 1-5.

The method 600 may begin with step S601, in which the first network function may receive, from the UE 101, a first message comprising UE information indicating UE Identity. In an embodiment, the UE Identity may be a dynamic UE Identity, for example UE IP address assigned in a PDU session establishment process.

In an embodiment, as shown in the above FIG. 2, the first message may be Service Provisioning Request message. In another embodiment, as shown in the above FIG. 3, the first message may be Service Provisioning Subscription Request message. In yet another embodiment, as shown in the above FIGS. 4 and 5, the first message may be UE Identifier API Request message. Furthermore, although not shown in the above FIGS. 2-5, the first message may be other messages sent over the EDGE-1 or EDGE-4 reference points, such as EEC Registration message, EAS discovery message, ACR initiation message, or ACR determination message.

Then, the method 600 may proceed to step S602, in which the first network function may obtain, from a mobile communication network (such as 3GPP Core Network 102), a static UE ID to be exposed, by using the received UE information (such as UE IP address). In an embodiment, the UE ID is the static UE ID.

In an embodiment, the static UE ID may be an application specific external ID, which may be assigned by an AF (such as the EAS 121) in the EDN 103 or be assigned by the mobile communication network (such as 3GPP Core Network 102).

In an embodiment, the first network function may interact with a network exposure function (such as the SCEF, NEF, or a combined SCEF+NEF), for retrieve the static UE ID, by using the received UE IP address.

Then, the method 600 may proceed to step S603, in which in response to the first message, the first network function may transmit, to the UE 101, a second message including the static UE ID, for exposing the static UE ID to UE.

In an embodiment, as shown in the above FIGS. 2-5, the second message may be a response message respective to the first message.

In an embodiment, as shown in the above FIGS. 4 and 5, the first network function further comprises an API (such as Eees_UEIdentifier API or Eecs_UEIdentifier API) specific for the first and second messages.

In an embodiment, as shown in the above FIGS. 2, 3, and 5, the first network function may be implemented in the ECS 123, and the first and second messages may be sent over EDGE-4 reference point between the EEC 112 in the UE 101 and the ECS 123.

In an embodiment, as shown in the above FIG. 4, the first network function may be implemented in the EES 122, and the first and second messages may be sent over EDGE-1 reference point between the EEC 112 in the UE 101 and the EES 122.

Note that, the static UE ID may be further exposed to other network function(s), for example, the UE 101 may initiate an EDGE-1 or EDGE-4 interactions and supply the static UE ID. Furthermore, as described with respect to FIGS. 4 and 5, the EES 122 and/or ECS 123 may expose the static UE ID for other purpose.

The above steps are only examples, and the first network function (such as the EES 122 or the ECS 123) may perform any actions described in connection to FIGS. 2-5, for obtaining and exposing the static UE ID, without security concern.

It should be understood that, a network function may be implemented either as a network element on a dedicated hardware, as a software instance running on a dedicated hardware, or as a virtualized function instantiated on an appropriate platform, e.g. on a cloud infrastructure.

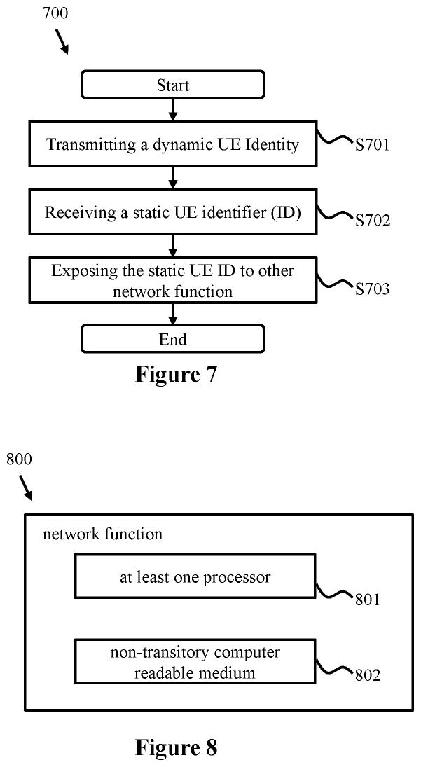

FIG. 7 is a schematic flow chart showing an example method 700 in the UE 101, according to the embodiments herein. In an embodiment, the flow chart in FIG. 7 may be implemented in a component (such as the EEC 112) in the UE, as shown in FIGS. 1-5.

The method 700 may begin with step S701, in which the UE 101 (for example the EEC 112 in the UE 101) may transmit, to a first network function implementing application data management function (such as the EES 122 or the ECS 123) in a data network (such as EDN 103), a first message comprising information indicating UE Identity. In an embodiment, the UE Identity may be a dynamic UE Identity, for example UE IP address assigned in a PDU session establishment process.

In an embodiment, as shown in the above FIG. 2, the first message may be Service Provisioning Request message. In another embodiment, as shown in the above FIG. 3, the first message may be Service Provisioning Subscription Request message. In yet another embodiment, as shown in the above FIGS. 4 and 5, the first message may be UE Identifier API Request message. Furthermore, although not shown in the above FIGS. 2-5, the first message may be other messages sent over the EDGE-1 or EDGE-4 reference points, such as EEC Registration message, EAS discovery message, ACR initiation message, or ACR determination message.

Then, the method 700 may proceed to step S702, in which the UE 101 may receive, from the first network function, a second message including a UE ID to be exposed. In an embodiment, the UE ID is a static UE ID.

In an embodiment, the static UE ID may be an application specific external ID, which may be assigned by an AF (such as the EAS 121) in the EDN 103 or be assigned by the mobile communication network (such as 3GPP Core Network 102).

In an embodiment, as shown in the above FIGS. 2-5, the second message may be a response message respective to the first message.

In an embodiment, as shown in the above FIGS. 4 and 5, the first network function further comprises an API (such as Eees_UEIdentifier API or Eecs_UEIdentifier API) specific for the first and second messages.

In an embodiment, as shown in the above FIGS. 2, 3, and 5, the first network function may be implemented in the ECS 123, and the first and second messages may be sent over EDGE-4 reference point between the EEC 112 in the UE 101 and the ECS 123.

In an embodiment, as shown in the above FIG. 4, the first network function may be implemented in the EES 122, and the first and second messages may be sent over EDGE-1 reference point between the EEC 112 in the UE 101 and the EES 122.

Then, the method 700 may proceed to step S703, in which the EEC 112 may transmit, to other network function(s), a third message including the static UE ID, for exposing the static UE ID. For example, the UE 101 may initiate an EDGE-1 or EDGE-4 interactions and supply the static UE ID.

The above steps are only examples, and the UE 101 (for example the EEC 112 in the UE) may perform any actions described with respect to FIGS. 2-5, for obtaining and exposing the static UE ID, without security concern.

FIG. 8 is a schematic block diagram showing an example first network function 800, according to the embodiments herein. In an embodiment, the first network function 800 may be implemented in an application data management function (such as the EES 122 or the ECS 123) in a data network (such as EDN 100), as shown in FIGS. 1-5.

In an embodiment, the first network function 800 may include at least one processor 801; and a non-transitory computer readable medium 802 coupled to the at least one processor 801. The non-transitory computer readable medium 802 contains instructions executable by the at least one processor 801, whereby the at least one processor 801 is configured to perform the steps in the example method 600 as shown in the schematic flow chart of FIG. 6; the details thereof are omitted here.

Note that, the first network function 800 may be implemented as hardware, software, firmware and any combination thereof. For example, the first network function 800 may include a plurality of units, circuities, modules or the like, each of which may be used to perform one or more steps of the example method 600 or one or more steps shown in FIGS. 2-5 related to the EES 122 and the ECS 123.

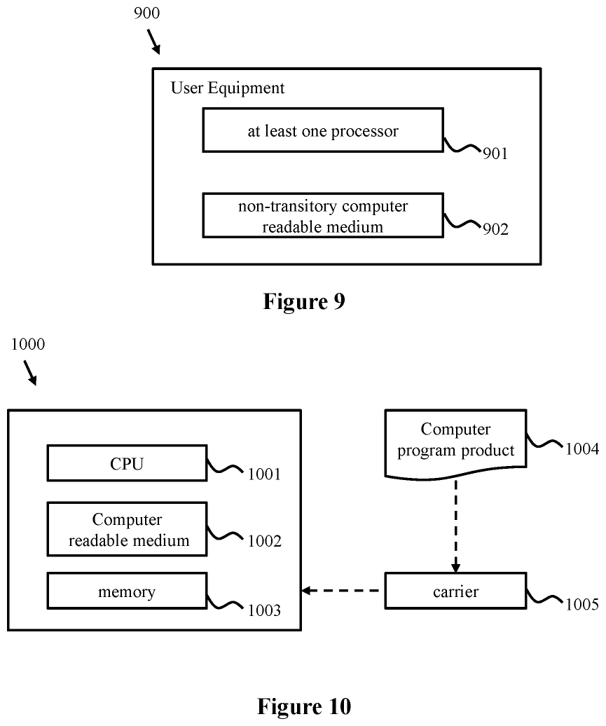

FIG. 9 is a schematic block diagram showing an example UE 900 (such as the UE 101), according to the embodiments herein. In an embodiment, the UE 900 may include a component (such as the EEC 112), as shown in FIGS. 1-5.

In an embodiment, the UE 900 may include at least one processor 901; and a non-transitory computer readable medium 902 coupled to the at least one processor 901. The non-transitory computer readable medium 902 contains instructions executable by the at least one processor 901, whereby the at least one processor 901 is configured to perform the steps in the example method 700 as shown in the schematic flow chart of FIG. 7; the details thereof are omitted here.

Note that, the UE 900 may include hardware, software, firmware and any combination thereof. For example, the UE 900 may include a plurality of units, circuities, modules or the like, each of which may be used to perform one or more steps of the example method 700 or one or more steps shown in FIGS. 2-5 related to the UE 101.

In some embodiments, the non-limiting term UE is used. UE 900 described herein can be any type of wireless device capable, configured, arranged and/or operable to communicate wirelessly with network nodes and/or another wireless device, for example over radio signals. Communicating wirelessly may involve transmitting and/or receiving wireless signals using electromagnetic signals, radio waves, infrared signals, and/or other types of signals suitable for conveying information through air. In particular embodiments, UE 900 may be configured to transmit and/or receive information without direct human interaction. For instance, a UE may be designed to transmit information to a network on a predetermined schedule, when triggered by an internal or external event, or in response to requests from the network.

Generally, UE may represent any device capable of, configured for, arranged for, and/or operable for wireless communication, for example radio communication devices. Examples of UE include, but are not limited to, smart phones. Further examples include wireless cameras, wireless-enabled tablet computers, laptop-embedded equipment (LEE), laptop-mounted equipment (LME), USB dongles, and/or wireless customer-premises equipment (CPE). UE 900 may also be a radio communication device, target device, D2D UE, machine-type-communication (MTC) UE or UE capable of machine-to-machine (M2M) communication, low-cost and/or low-complexity UE, a sensor equipped with UE, Tablet, mobile terminals, an Internet of Things (IoT) device, or a Narrowband IoT (NB-IoT) device, or any other suitable devices.

As one specific example, a UE may be configured for communication in accordance with one or more communication standards promulgated by the 3rd Generation Partnership Project (3GPP), such as 3GPP's Global System for New Radio (NR), Mobile Communications (GSM), Universal Mobile Telecommunications System (UMTS), Long Term Evolution (LTE), and/or other suitable 2G, 3G, 4G or 5G standards or other suitable standards. As used herein, a “UE” may not necessarily have a “user” in the sense of a human user who owns and/or operates the relevant device. Instead, a UE may represent a device that is intended for sale to, or operation by, a human user but that may not initially be associated with a specific human user.

FIG. 10 is a schematic block diagram showing an example computer-implemented apparatus 1000, according to the embodiments herein. In an embodiment, the apparatus 1000 may be configured as the above mentioned apparatus, such as the UE 101, the EES 122, and the ECS 123.

In an embodiment, the apparatus 1000 may include but not limited to at least one processor such as Central Processing Unit (CPU) 1001, a computer-readable medium 1002, and a memory 1003. The memory 1003 may comprise a volatile (e.g. Random Access Memory, RAM) and/or non-volatile memory (e.g. a hard disk or flash memory). In an embodiment, the computer-readable medium 1002 may be configured to store a computer program and/or instructions, which, when executed by the processor 1001, causes the processor 1001 to carry out any of the above mentioned methods. In an embodiment, the computer-readable medium 1002 (such as non-transitory computer readable medium) may be stored in the memory 1003. In another embodiment, the computer program may be stored in a remote location for example computer program product 1004 (also may be embodied as computer-readable medium), and accessible by the processor 1001 via for example carrier 1005.

The computer-readable medium 1002 and/or the computer program product 1004 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

Abbreviations

| | |
|---|---|
| 3GPP | third Generation Partnership Project |
| ACR | Application Context Relocation |
| AF | Application Function |
| API | Application Programming Interface |
| DNN | Data Network Name |
| EAS | Edge Application Server |
| ECS | Edge Configuration Server |
| ECSP | Edge Computing Service Provider |
| EDN | Edge Data Network |
| EEC | Edge Enabler Client |
| EES | Edge Enabler Server |
| GPSI | Generic Public Subscription Identifier |
| ID | Identifier |
| IP | Internet Protocol |
| LADN | Local Area Data Network |
| MSISDN | Mobile Subscriber Integrated Services Digital Network |
| | Number |
| NEF | Network Exposure Function |
| PCRF | Policy and Charging Rules Function |
| PCF | Policy Control Function |
| PDU | Packet Data Unit |
| SCEF | Service Capability Exposure Function |
| UE | User Equipment |
| USIM | Universal Subscriber Identity Module |
| URI | Uniform Resource Identifier. |

1-11. (canceled)

12. A method performed by a User Equipment (UE), comprising:
transmitting, to a first network function implementing application data management function in a data network, a first message comprising UE information indicating a dynamic UE identifier (ID).

13. The method according to claim 12, further comprising:
receiving, from the first network function, a second message including a static UE identifier (ID) to be exposed.

14. The method according to claim 13, further comprising:
transmitting, to a second network function, a third message including the static UE ID, for exposing the static UE ID.

15. The method according to claim 12, wherein the UE information indicates UE Internet Protocol (IP) address assigned in a Packet Data Unit (PDU) session establishment process.

16. The method according to claim 13, wherein the static UE ID is an application specific external ID assigned by a third network function in the data network or in a mobile communication network.

17. The method according to claim 13, wherein the first and second messages are sent over an Application Programming Interface (API) specific for the first and second message.

18-19. (canceled)

20. The method according to claim 13, wherein the first network function is implemented in an Edge Enabler Server (EES),
wherein the first and second messages are sent over EDGE-1 reference point between an Edge Enabler Client (EEC) in the UE and the EES.

21. The method according to claim 20, wherein the first message is any one of UE Identifier API Request message, EEC Registration message, Edge Application Server (EAS) discovery message, or Application Context Relocation (ACR) message; and wherein the second message is a response message respective to the first message.

22. (canceled)

23. An User Equipment (UE), comprising:
at least one processor; and
a computer readable storage medium, the computer readable storage medium containing instructions which, when executed by the at least one processor, cause the UE to:
transmit, to a first network function implementing application data management function in a data network, a first message comprising UE information indicating a dynamic UE identifier (ID).

24-25. (canceled)

26. The UE according to claim 23, further comprising:
receiving, from the first network function, a second message including a static UE identifier (ID) to be exposed.

27. The UE according to claim 26, further comprising:
transmitting, to a second network function, a third message including the static UE ID, for exposing the static UE ID.

28. The UE according to claim 23, wherein the UE information indicates UE Internet Protocol (IP) address assigned in a Packet Data Unit (PDU) session establishment process.

29. The UE according to claim 26, wherein the static UE ID is an application specific external ID assigned by a third network function in the data network or in a mobile communication network.

30. The UE according to claim 26, wherein the first and second messages are sent over an Application Programming Interface (API) specific for the first and second message.

31. The UE according to claim 26, wherein the first network function is implemented in an Edge Enabler Server (EES),
wherein the first and second messages are sent over EDGE-1 reference point between an Edge Enabler Client (EEC) in the UE and the EES.

32. The UE according to claim 31, wherein the first message is any one of UE Identifier API Request message, EEC Registration message, Edge Application Server (EAS) discovery message, or Application Context Relocation (ACR) message; and wherein the second message is a response message respective to the first message.
